(19) United States
(12) Patent Application Publication
(10) Pub. No.: US 2006/0239656 A1
(43) Pub. Date: Oct. 26, 2006

(54) Recording medium for storing video file and method for editing video file

(76) Inventors: Po-Wei Lin, Taichung City (TW); Chun-Tang Weng, Cishan Township (TW)

Correspondence Address: J C PATENTS, INC., 4 VENTURE, SUITE 250, IRVINE, CA, 92618, US

(21) Appl. No.: 11/165,649

(22) Filed: Jun. 23, 2005

(30) Foreign Application Priority Data
Apr. 12, 2005 (TW) 94111442

(51) Int. Cl. H04N 7/26

(52) U.S. Cl. 386/112

(57) ABSTRACT

A recording medium for storing video files and a method for editing video files are disclosed. In the method, when a video file is stored in a computer-accessible recording medium for storing video files of the present invention, the end positions of groups of pictures (GOPs) align with cluster boundaries of the computer-accessible recording medium. When editing the video file, implementation points are also at cluster boundaries of the recording medium. Therefore, the original video file is directly split by modifying the cluster-chain relationship and the file length of the corresponding file descriptor in the recording medium, without copying and moving actual data in the computer-accessible recording medium. Consequently, the efficiency of editing video files is enhanced.

### CROSS-REFERENCE TO RELATED APPLICATION

This application claims the priority benefit of Taiwan application serial no. 94111442, filed on Apr. 12, 2005. All disclosure of the Taiwan application is incorporated herein by reference.

### BACKGROUND OF THE INVENTION

1. Field of Invention

The present invention relates to a method for storing files, and particularly to a method for storing video files in a recording medium.

2. Description of the Related Art

Nowadays, video object (VOB) files are stored in a computer-accessible recording medium in the conventional technology, such as a hard disc. When a digital video equipment is editing the video file, it is inevitable to include operations of copying and moving the actual video data of the file since the unit length of a group of pictures (GOP) of a video file differs from a minimum allocation unit, i.e. a cluster, of a file system in a computer-accessible recording medium.

FIG. 1 is a schematic flowchart showing an operation of splitting a video file in a conventional file system in the prior art. In step S110, a user decides a split point of a video file. In step S120, an original file to be split, a new file A and a new file B are opened. In step S130, the original file is accessed and the data is written into the new file A. In step S140, it is determined whether there is a split point when reading the original file. If no split point is encountered, the operation of accessing the original file and writing the data into the new file A continues. However, if a split point is encountered, the process goes into step S150, in which the accessed data from the original file is written into the new file B. In step S160, it is determined whether the accessed original file has reached an end during the accessing and writing process. If not, the operation of accessing the original file and writing the accessed data into the new file B continues. If yes, the original file is closed and deleted, and the new file A and file B are also closed.

FIG. 2 is a schematic diagram of cutting and linking data in an operation of splitting a video file in a conventional file system in the prior art. In FIG. 2, C1 to C7 represent an original cluster-chain and data1 to data4 represent the video data to be processed, which may include one GOP or a plurality of GOPs. A split point 210 positioned by a user splits the original GOPs into a split file A (220) and another split file B (230). When the split point 210 positioned by a user is located inside data3, the split file A includes not only C1 to C4 among the original cluster-chain, but also a portion of C5 antecedent to the split point. The remaining portion of C5 is filled by a group of padding packs. Meanwhile, the length of the split file A is modified to include the data end of the split file. The split file B includes C6 and C7 of the original cluster-chain, and the data subsequent to the split point in the data 3 needs to be copied. The remaining portion of data 3 is filled by a group of padding packs 240. Finally, the copied portion and the filled portion are linked to the cluster-chain beginning of the split file B. Meanwhile, the length of the split file B and the data offset are modified to update the beginning position for accessing the data. After the steps for splitting the above-mentioned file are completed, a plurality of navigation packs of the split file is finally modified to complete all procedures for splitting files.

The above method requires copying and moving the actual data. Due to the enormous data size of the common video files, such copying and moving operations would consume a lot of time and result in low execution efficiency, so highly efficient data processing can not be achieved.

### SUMMARY OF THE INVENTION

Accordingly, an object of the present invention is to provide a computer-accessible recording medium for storing video files. When a video file is stored, the end position of a group of pictures (GOP) of the video file is aligned with a cluster boundary of a computer-accessible recording medium for storing video files, to avoid copying and moving of the actual file data in a computer-accessible recording medium when editing a video file, thereby enhancing the efficiency of editing video files.

Another object of the present invention is to provide a method for editing video files, in particular, a splitting method for editing video files. In this method, a video file is split into two segments using the above computer-accessible recording medium for storing video files, to directly split an original video file by modifying both the cluster-chain and the file lengths of a corresponding file descriptor in the recording medium, thereby enhancing the efficiency of editing video files.

A further object of the present invention is to provide a method for editing video files, in particular, a cutting and linking method for editing video files. In the method, a video file is split and a specified range of a video file is cut out using the above computer-accessible recording medium for storing video files, to directly split and cut out a specified range of the video file through modifying the cluster-chain and the file lengths of a corresponding file descriptor in the recording medium, thereby enhancing the efficiency of editing video files.

The present invention provides a computer-accessible recording medium for storing video files, wherein the data length of a video file is an integer multiplication product of a first boundary length. The video file includes at least a group of pictures (GOP). When the data length of any GOP is not an integer multiplication product of the first boundary length, the GOP further comprises at least a padding pack, wherein the total data length of the GOP and the padding packs is an integer multiplication product of the first boundary length.

According to the computer-accessible recording medium for storing video files in an embodiment of the present invention, the data length of each above-described GOP is an integer multiplication product of a second boundary length. In addition, the total data length of the GOP and the padding packs is an integer multiplication product of the first boundary length, and an integer multiplication product of the second boundary length.

According to the computer-accessible recording medium for storing video files in an embodiment of the present invention, the above-described second boundary length is the data length of the video packs, audio packs, or padding packs in a recording medium.

According to the computer-accessible recording medium for storing video files in an embodiment of the present invention, the above-described first boundary length is the length of a cluster in a recording medium.

According to the computer-accessible recording medium for storing video files in an embodiment of the present invention, each above-described padding pack has a size of 2 KB.

The present invention provides a method for editing video files, wherein a video file is split into a first video file and a second video file using the above-described computer-accessible recording medium for storing video files. In the beginning, a split point decided and entered by a user is positioned, wherein the split point is located at an end position of any group of pictures (GOP). Then, the file descriptors for the first video file and the second video file are established. Finally, the file length of the file descriptor for the first video file is modified into the original cluster-chain length antecedent to the split point, which is then linked to the first video file. Theresubsequent to, the file length of the file descriptor for the second video file is modified into the original cluster-chain length subsequent to the split point, which is then linked to the second video file.

The present invention provides a method for editing video files, wherein a video file is split and a specified range of video data in a video file is cut out using the above-described computer-accessible recording medium for storing video files. In the beginning, a first split point and a second split point decided and entered by a user are positioned, wherein the first split point and the second split point are located at the end positions of any group of pictures (GOP), respectively, and the second split point is subsequent to the first split point. Between the first split point and the second split point is an abandoning length. Then, the part of the original cluster-chain antecedent to the first split point and the part of the original cluster-chain subsequent to the second split point are linked, and the part of the original cluster-chain between the first split point and the second split point is released. Finally, the file length of the file descriptor for the video file is modified into the original cluster-chain length minus the removed abandoning length.

Accordingly, in the method for editing video files of the present invention, since an implementation point for editing a video file is located at a cluster boundary of a recording medium, the original video file is directly split by modifying the cluster-chain and file length of a corresponding file descriptor in the recording medium, without copying and moving the actual file data in a computer-accessible recording medium. Therefore, the efficiency of editing video files is enhanced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a schematic flowchart showing an operation of splitting a video file in a conventional file system in the prior art.

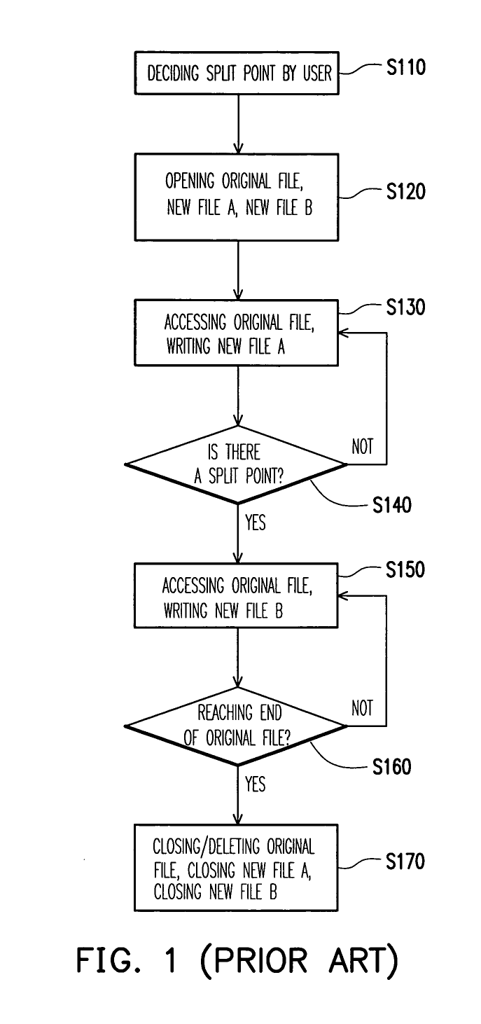

FIG. 2 is a schematic diagram of cutting and linking data in an operation of splitting a video file in a conventional file system in the prior art.

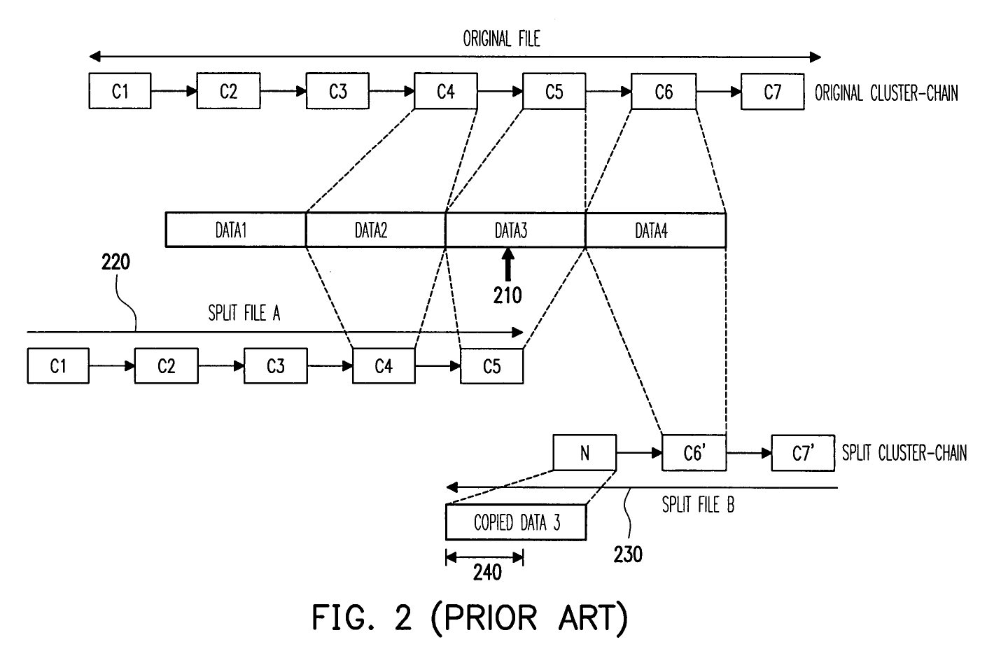

FIG. 3 is a schematic diagram in a computer-accessible recording medium for storing video files according to an embodiment of the present invention.

FIG. 4 is a schematic flowchart showing an operation of splitting data in a video file according to an embodiment of the present invention.

FIG. 5 is a schematic diagram of splitting data in a video file according to an embodiment of the present invention.

FIG. 6 is a schematic flowchart showing an operation of cutting and linking data in a video file according to an embodiment of the present invention.

FIG. 7 is a schematic diagram of cutting and linking data in a video file according to an embodiment of the present invention.

### DESCRIPTION OF THE EMBODIMENTS

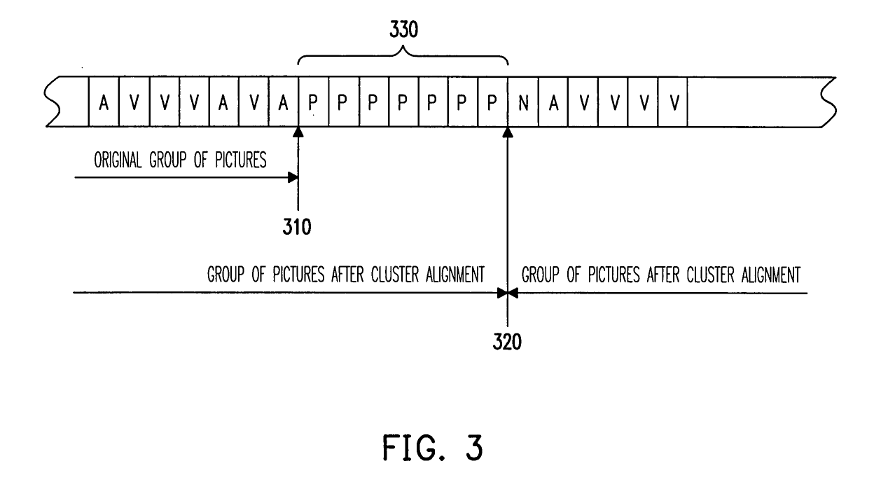

FIG. 3 is a schematic diagram in a computer-accessible recording medium for storing video files according to an embodiment of the present invention, wherein an original group of pictures (GOP) is stored in a recording medium in cluster alignment manner when storing a video file. If the end position 310 of the original GOP is not at a cluster boundary 320, a group of padding packs 330 is added subsequent to the original GOP, until the end position of the GOP reaches the cluster boundary 320. Wherein, each of the padding packs has a size of 2 KB. In this way, the size of each GOP is restricted to an integer multiplication product of a cluster size. In addition, the size of each GOP is also an integer multiplication product of the data-pack length of the recording medium. Wherein, the data-pack length includes, for example, the data length of video packs, the data length of audio packs and the data length of padding packs. The alignment of the end position of a GOP is not limited to the above-mentioned cluster alignment manner. Any one skilled in the art is able to use a different position for alignment depending on an actual situation without departing from the scope or spirit of the invention.

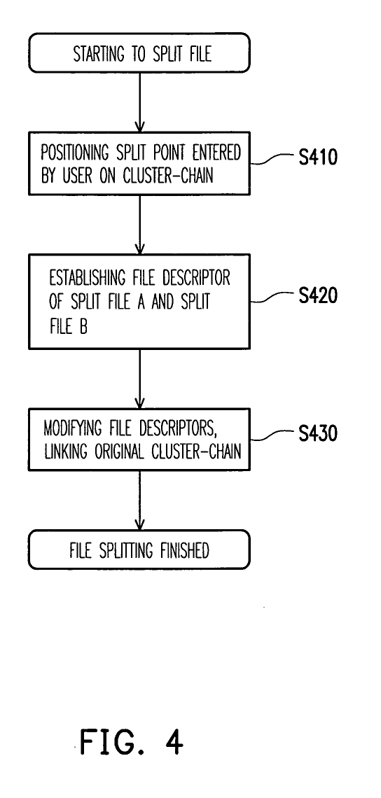

FIG. 4 is a schematic flowchart showing an operation of splitting data in a video file according to an embodiment of the present invention. In the operation process, the above-described file descriptor in the computer-accessible recording medium for storing video files is used. To split a video file, at the beginning, a split point decided and entered by a user on a cluster-chain is positioned, then the original cluster-chain at the split point is split into two segments (the step S410). Then, the file descriptors for a new split file A and a new split file B are established (the step S420). Finally, the file length in the file descriptor for the newly established split file A is modified to the original cluster-chain length antecedent to the split point and the original cluster-chain antecedent to the split point is linked to the split file A, while the file length in the file descriptor for the newly established split file B is modified to the original cluster-chain length subsequent to the split point and the original cluster-chain subsequent to the split point is linked to the split file B (the step S430).

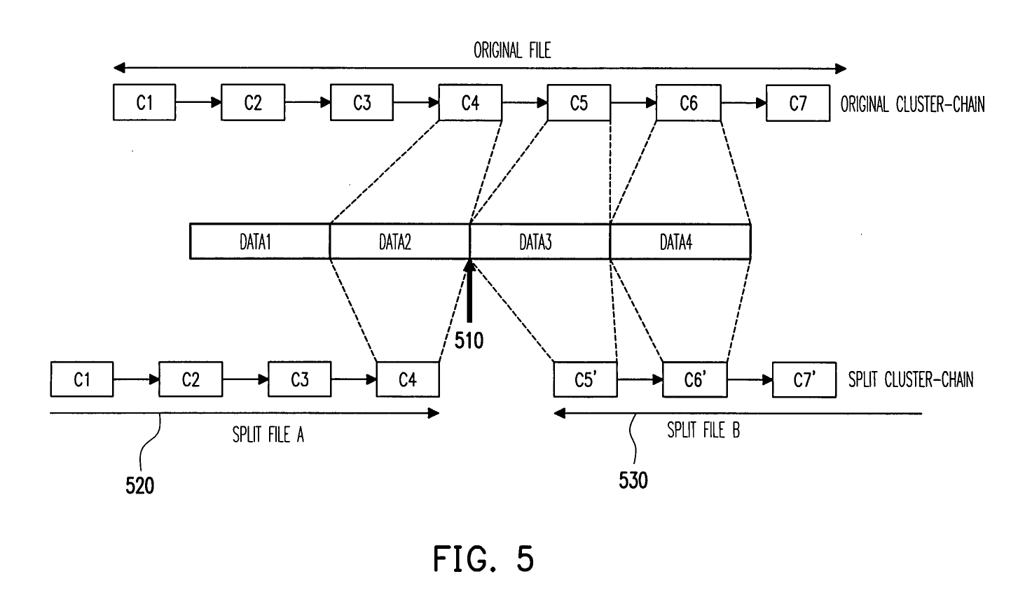

FIG. 5 is a schematic diagram of splitting data in a video file according to an embodiment of the present invention. Wherein, C1 to C7 represent an original cluster-chain of original files and data1 to data4 represent a plurality of groups of pictures (GOPs). A split point 510 for splitting the files is located at the boundary of data2 and data3, i.e. the boundary of the corresponding clusters. Therefore, the newly established split file A (520) subsequent to the splitting can be directly linked to the original clusters C1 to C4, and the split file B (530) can be directly linked to the original clusters C5 to C7, without copying and moving the file data. In the above-described embodiment, the file splitting at a single split point at a single position is only exemplary, and the present invention is not limited to a single split point and a single implementation position. One of ordinary skill in the art is able to decide the number of the split point and the implementation position.

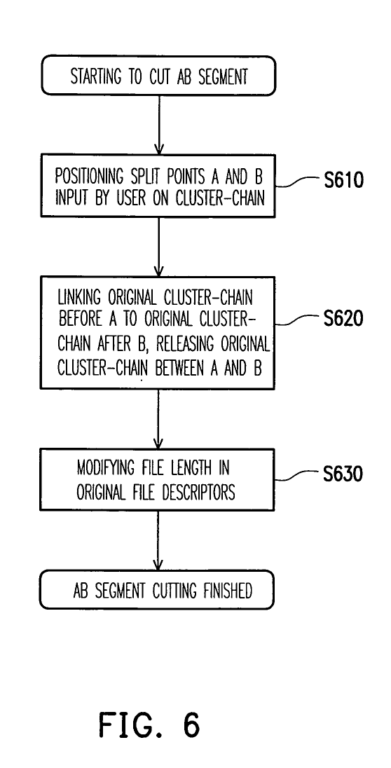

FIG. 6 is a schematic flowchart showing an operation of cutting and linking data of a video file according to an embodiment of the present invention. In the operation process, the above-described file descriptor in the computer-accessible recording medium for storing video files is used. To cut out an AB segment from an original file, at first, a split point A and a split point B decided and entered by a user on a cluster-chain are positioned (the step S610). Wherein, the split point A and the split point B are at the end positions of any GOP, respectively and the split point B is subsequent to the split point A. Between the split point A and B is an abandoning length. Then, the part of the original cluster-chain antecedent to the split point A and the part of the original cluster-chain subsequent to the split point B are linked (the step S620). In the end, the file length in the file descriptor of the original video file is modified to the original cluster-chain minus the removed abandoning length (the step S630).

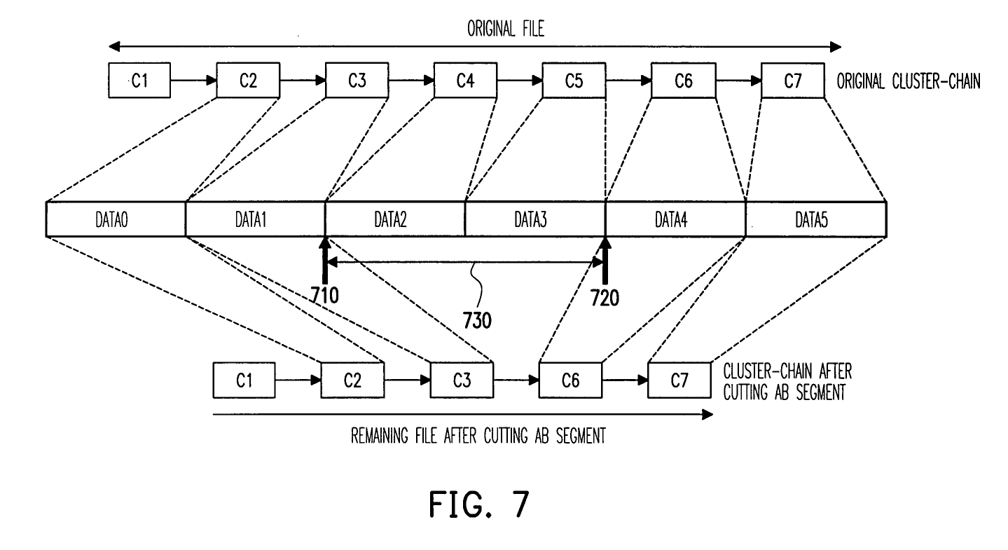

FIG. 7 is a schematic diagram of cutting and linking data in a video file according to an embodiment of the present invention. Wherein, C1 to C7 represent an original cluster-chain and data0 to data5 represent a plurality of groups of pictures (GOPs). A split point A (710) and a split point B (720) decided and entered by a user are used for splitting and releasing the data 730 between the split point A (710) and the split point B (720) from the original groups of pictures (GOPs). The remaining file subsequent to the splitting is stored in the original video file. Wherein, the remaining file only includes C1, C2, C3, C6 and C7 in the original cluster-chain. In the above-described embodiment, the file splitting of a single file length at a specified implementation position is only exemplary, and the present invention is not limited to a fixed file length and a single position. One of ordinary skill in the art is able to decide the file length and the specified positions without departing from the scope of the present invention.

Accordingly, in the computer-accessible recording medium for storing video files of the present invention, boundaries of the GOPs thereof align with boundaries of clusters. The editing points of video files, i.e. the points to edit video files, are located at boundaries of GOPs. Therefore, during an editing process of video files, the file can be edited by directly modifying the cluster relationship and the file lengths of the corresponding file descriptors in a file system, without copying and moving the actual file data in a storage medium. Thus, the efficiency of editing video files is enhanced.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A computer-accessible recording medium for storing video files, wherein the data length of the video file is an integer multiplication product of a first boundary length of the recording medium; the video file comprising:
at least a group of pictures (GOP), wherein if the data length of any GOP is not an integer multiplication product of the first boundary length, the GOP further comprises
at least a padding pack, wherein the total data length of the GOP and the padding packs is an integer multiplication product of the first boundary length.

2. The computer-accessible recording medium for storing video files as recited in claim 1, wherein the data length of any GOP is an integer multiplication product of a second boundary length, and the total data length of the GOP and the padding packs is, an integer multiplication product of the first boundary length, and an integer multiplication product of the second boundary length.

3. The computer-accessible recording medium for storing video files as recited in claim 2, wherein the second boundary length is the data length of video packs, audio packs, or padding packs of the recording medium.

4. The computer-accessible recording medium for storing video files as recited in claim 1, wherein the first boundary length is a cluster boundary length of the recording medium.

5. The computer-accessible recording medium for storing video files as recited in claim 1, wherein the padding pack has a size of 2 KB.

6. A method for editing video files for splitting a first video file into a second video file and a third video file, wherein the data length of the first video file is an integer multiplication product of the first boundary length, and the first video file comprises at least a GOP; when the data length of any GOP is not an integer multiplication product of the first boundary length, the GOP further comprises at least a padding pack, so that the total data length of the GOP and the padding packs is an integer multiplication product of the first boundary length; the editing method comprising:
positioning a split point decided and entered by a user, wherein the split point is located at an end position of any GOP;
establishing a file descriptor for the second video file and a file descriptor for the third video file; and
modifying the file length of the file descriptor for the second video file to a part of the original cluster-chain length antecedent to the split point, and linking the part of the original cluster-chain preceding the split point to the second video file; modifying the file length of the file descriptor for the third video file to a part of the original cluster-chain length subsequent to the split point, and linking the part of the original cluster-chain subsequent to the split point to the third video file.

7. The method for editing video files as recited in claim 6, wherein the data length of each GOP is an integer multiplication product of a second boundary length, and the total data length of the GOP and the padding packs is an integer multiplication product of the first boundary length, and an integer multiplication product of the second boundary length.

8. A method for editing video files, wherein the data length of the video file is an integer multiplication product of the length of a first boundary, and the video file comprises at least a GOP; when the data length of any GOP is not an integer multiplication product of the first boundary length, the GOP further comprises at least a padding pack, so that the total data length of the GOP and the padding packs is an integer multiplication product of the first boundary length; the editing method comprising:
positioning both a first split point and a second split point decided and entered by a user, wherein the first split point and the second split point are located at end positions of any GOP, respectively, the second split point is subsequent to the first split point, and between the first split point and the second split point is an abandoning length;
linking the part of the original cluster-chain antecedent to the first split point to the part of the original cluster-chain subsequent to the second split point and releasing the part of the original cluster-chain between the first split point and the second split point; and
modifying the file length of the file descriptor for the video file to the original cluster-chain length minus the removed abandoning length.

9. The method for editing video files as recited in claim 8, wherein the data length of each GOP is an integer multiplication product of the second boundary length, and the total data length of the GOP and the padding packs is an integer multiplication product of the first boundary length, and an integer multiplication product of the second boundary length.
